(19) United States
(12) Patent Application Publication
(10) Pub. No.: US 2026/0362048 A1
(43) Pub. Date: Nov. 12, 2026

(54) Vibration Management System with Panels in Combination with Particle Impact Damping for Loudspeaker Cabinets

(71) Applicant: Theodore Joseph Stack, Devon (GB)

(72) Inventor: Theodore Joseph Stack, Devon (GB)

(21) Appl. No.: 19/530,202

(22) Filed: Feb. 4, 2026

Related U.S. Application Data
(60) Provisional application No. 63/753,999, filed on Feb. 5, 2025.

(51) Int. Cl. H04R 1/28; G10K 11/162

(52) U.S. Cl. CPC H04R 1/288; G10K 11/162

(57) ABSTRACT

The present disclosure generally relates to a vibration management system for loudspeaker cabinets that improves audio fidelity by reducing cabinet-borne resonances. The system comprises one or more panels mounted within the loudspeaker cabinet, each panel incorporating one or more particle impact damping (PID) chambers. The panel mechanically couple cabinet vibrations into the PID chambers, where vibrational energy is dissipated as heat through particle collisions and friction. The PID chambers may contain particles of differing sizes, shapes, materials, and fill levels to provide effective broadband damping across the audible frequency range. By suppressing cabinet-induced vibration and resonance, the system reduces parasitic sonic artifacts and preserves the clarity and accuracy of sound reproduction.

### CROSS-REFERENCE TO RELATED APPLICATIONS

This application claims the benefit of U.S. Provisional Application No. 63/753,999, filed Feb. 5, 2025, the contents of which are incorporated herein by reference.

### FIELD

The present disclosure generally relates to the management and mitigation of vibration within hi-fi audio loudspeaker cabinets. The present disclosure provides a system and method for absorbing vibrations through the incorporation of one or more panels in combination with particle impact damping (PID). In one arrangement, the panel comprises a deformable panel. However, as those of ordinary skill in the art will recognize, alternative panel types may be used as well.

### BACKGROUND

The present disclosure optimizes vibration absorption and resonance control in hi-fi loudspeaker cabinets, leading to enhanced sound clarity and reduced mechanical vibration across a broad range of frequencies. The systems and methods disclosed herein are applicable to the design, manufacture, and improvement of loudspeaker enclosures where reduction of structural vibration is desired to improve audio performance.

### SUMMARY

In one arrangement, a speaker cabinet vibration management system comprises a panel disposed within an interior of a loudspeaker cabinet and configured to flex in response to cabinet vibrations so as to transmit the vibrations; and a plurality of particle impact dampers (PIDs) integrated into the panel, each PID comprising an enclosed chamber containing loose particles that dissipate the transmitted vibrations through collisions with each other and with the walls of the chamber.

In one arrangement, the panel is constructed from at least one compliant material selected for its elasticity, density, and compatibility with the loudspeaker cabinet's internal structure.

In one arrangement, the panel comprises a rigid support frame and a compliant layer on an outward-facing surface of the frame, the compliant material being selected based on its elasticity, density, and compatibility with the loudspeaker cabinet's internal structure.

In one arrangement, a PID contains particles of varying sizes, fill levels, shapes, and material compositions to enable vibration damping across a broad range of frequencies.

In one arrangement, the panel is positioned strategically within the loudspeaker cabinet to maximize the transmission of mechanically induced cabinet vibration into the particle impact dampers.

In one arrangement, a PID is configured to dissipate vibration through particle collisions and friction, thereby reducing the amplitude of the cabinet vibrations.

In one arrangement, the panel facilitates the transmission of vibration into a PID, thereby enhancing the efficiency of energy dissipation.

In one arrangement, the panel and a PID form a modular system that allows the number and placement of damping components to be customized for different loudspeaker cabinet designs and internal configurations.

In one arrangement, the panel and a PID provide vibration damping across a broad frequency range, thereby improving audio fidelity by reducing parasitic vibrations in the loudspeaker cabinet.

In one arrangement, the panel is attached within the cabinet by at least one of: an adhesive, glue, screws, adhesive tape, clips, or other fasteners.

In one arrangement, the panel is held in place by magnets, friction fit, or tensioning mechanisms.

In one arrangement, the panel is embedded into a pre-formed pocket or recess in the interior surface of the loudspeaker cabinet.

In one arrangement, the panel is flat, curved, or sufficiently flexible to conform to both planar and curved interior surfaces of the cabinet.

In one arrangement, the panel is arranged across one or more interior walls of the loudspeaker cabinet.

In one arrangement, the panel is square, rectangular, wedge-shaped, circular, oval, or another custom shape sized to fit into spaces between internal cabinet bracing members.

In one arrangement, the panel comprises a rigid or a semi-rigid panel.

In one arrangement, the rigid or semi-rigid panel may be employed when mounted with a compliance-enhancing layer, allowing for effective vibration coupling to the PID mechanism.

In one arrangement, a method for reducing vibrations in a loudspeaker cabinet, comprising providing a loudspeaker cabinet and installing a panel in an interior of the cabinet; embedding a particle impact damper (PID) within the panel; capturing vibrations generated by the speaker drivers using the panel; and dissipating the captured vibrations through movement of particles within the PID.

In one arrangement, the panel is positioned to optimize a transmission of vibrations into the PID.

In one arrangement, the step of selecting properties of the particles, including particle size, fill level, shape, and material composition, to provide damping across a broad range of frequencies.

In one arrangement, the damping system reduces the amplitude of vibrations in the cabinet, thereby improving audio fidelity by minimizing parasitic sound artifacts.

In one arrangement, the panel and the PID are configured to be scalable and customizable to accommodate different loudspeaker cabinet designs and applications.

In one arrangement, the panel comprises a deformable panel.

In one arrangement, the panel comprises a rigid or a semi-rigid panel.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a section view of a loudspeaker cabinet comprising an enclosure and a plurality of PID panels mounted on interior cabinet surfaces, showing one example arrangement of the vibration management system; and

FIG. 2 illustrates a panel containing a PID chambers filled with particles of differing sizes, demonstrating the particle impact damping mechanism used to dissipate vibrational energy.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A high-fidelity system, also known as high fidelity audio, or hi-fi audio, is audio that is very high quality. The factors that play into this level of quality are a high accuracy at reproducing the audible frequencies in an audio recording, with limited distortion in the original audio signal. Hi-fi has been described as sounding clear, clean, crisp, and free from distortion and other unwanted sonic artifacts. This in general is what high fidelity or “hi-fi” means.

In certain situations, vibrations originating in loudspeaker cabinets can affect the nature and quality of audio reproduction. Unwanted vibrations from loudspeaker cabinets can cause noise, harmonic distortions, phase issues, echoes, time smearing and a reduction in clarity of the audible sound signal, impairing the accurate reproduction of the music. Vibrations, when transmitted through room structures like floors or walls, can cause such structures to emit resonances, interfering with the primary audio signal. Controlling and damping vibrations originating in loudspeakers is important to preserving the true essence and quality of hi-fi audio playback.

In certain systems, loudspeaker cabinets can play a crucial role in the overall sound quality of audio systems, but they are often overlooked as a source of unwanted distortions. When speakers produce sound, they generate both acoustic pressure waves and mechanical vibrations within the cabinet.

Internal air pressure changes can also induce vibrations in the cabinet structure. Both the mechanical and air pressure induced vibrations can significantly impact the fidelity of the sound. The terms ‘loudspeakers’ and ‘loudspeaker cabinets’ for the purposes of the present disclosure refer to all types of loudspeakers using enclosures or baffles to mount and house the speaker drivers, such as, but not limited to, passive and active full range loudspeakers and sub-woofers, sealed, ported and passive radiator types, transmission line, open baffle, bandpass enclosures and horns.

Air pressure changes occur as the speaker drivers move back and forth, creating sound waves. Within sealed or ported cabinets or one with a passive radiator, these movements cause fluctuating internal air pressure. The air pressure changes can cause the cabinet to reverberate and produce additional sound. This results in distortion or muddy sound, particularly affecting the midrange where cabinet vibrations dominate, and the high frequencies.

Mechanically induced cabinet vibrations can also present an issue. When the speaker driver operates to produce sound, it induces vibrations in the cabinet through dynamic forces. As the driver moves, it exerts force on its mounting points, transferring energy to the cabinet structure which can interfere with the original signal, creating phase issues and introducing coloration to the sound. This can lead to a loss of clarity and detail, as the speaker output gets masked by the sound waves produced by the cabinet vibration. In addition, bass drivers in particular will exert or input forces and vibrations into the speaker cabinet that will feedback directly into all the speaker drivers. This vibration is out of phase and noisy by nature and can significantly affect the mid and high frequency drivers.

Vibration originating in the loudspeaker cabinet can also travel down the speaker cabinet/housing (and speaker stand if used) into the floor and the furniture. This then makes the room and surrounding structures, such as, for example, floorboards, walls, furniture, act as radiating surfaces which distorts the audible soundwaves and creates vibrations that affect the other hi-fi components (turntable and electronics) creating microphony in electronic circuits, degrading the audio signal.

Effectively managing cabinet vibrations can be essential for maintaining clear, accurate, and uncolored sound. Without proper control, the sound waves emanating from the drivers and the cabinet's own dynamic response combine in a way that degrades the original audio signal. The present disclosure provides means of managing cabinet vibrations within a loudspeaker however they are induced.

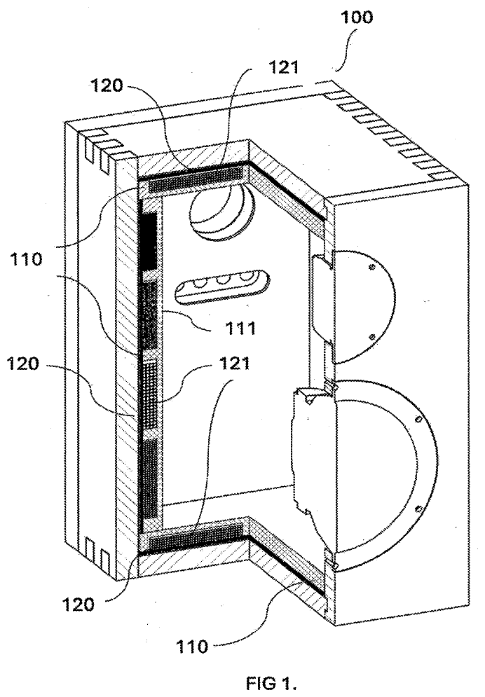

FIG. 1 illustrates a typical rectangular loudspeaker cabinet where 100 forms the outer casing of the loudspeaker. Multiple panels 110 are situated within and mechanically coupled to the loudspeaker cabinet 100. In one preferred arrangement, each panel comprises a mechanical vibration-coupling interface that converts cabinet vibration into particle motion more effectively than a rigid structure. The panels 110 are made of a compliant material capable of transmitting vibration. The compliant material (foam, silicone, rubber or other) can be selected based on its mechanical properties, including elasticity, durability, and compatibility with the speaker cabinet's internal structure. The panels 110 could be attached by various methods such as, but not limited to, adhesive glue, screws, self-adhesive tape, clips and fasteners, or held in place by magnets, friction, or tensioning mechanisms or embedded into pockets within the speaker cabinet.

Panels 110 are strategically placed within the speaker cabinet to capture and direct vibrations toward the Particle Impact Dampers (PIDs). The PIDs comprise chambers 120 which are filled with particles 121.

Particle Impact Damping (PID) is a technology that employs particles held within a confined space or chamber that collide with each other and the chamber walls when subjected to vibrations. The collisions dissipate the vibrational energy by turning this vibrational energy into heat. As the vibrations affecting a hi-fi loudspeaker system are complex and multi-axis in nature, the shape of the PID chamber(s) within the embodiments are designed to optimize contact between the particles and between the particles and the chamber walls in three-dimensions.

The panels 110 address cabinet vibrations. The panel composed of a compliant material (foam, silicone, rubber or other) strategically incorporates multiple internal PID chambers 120 to address specific vibration absorption needs.

In one arrangement, the panels comprise a deformable panel. For example, the deformable nature of the panels is to transmit and condition the vibration to the PID particles so that the PID works by improving energy transfer into the particles, increasing collision frequency and enhancing energy dissipation efficiency.

A combination of the panel and tailored particle fillings 121 aims to enhance the speaker's performance by improving sound clarity, minimizing distortion, and creating a more immersive audio experience. The panels could be entirely constructed from a compliant material or alternatively could comprise a rigid frame with a compliant outward facing surface (i.e. the surface that faces the open internal space inside the loudspeaker cabinet). The rear side of the panel that attaches to the cabinet wall transmits cabinet vibration directly through to the PID particles.

While deformable panels represent on preferred method for efficient vibration transfer, alternative panel configurations and arrangements may be utilized. For example, alternative configurations may include panels having rigid or semi-rigid structures, provided sufficient energy transfer into the PID chambers is maintained. This may include rigid materials mounted via compliant interfaces or hybrid panels with deformable surface zones.

The panels 110 can be of varying sizes and shapes to fit inside different designs and constructions of loudspeaker cabinet. Panels may be flat, curved, or flexible; may contain one or multiple PID chambers; and may be distributed across cabinet walls or positioned near vibration-intensive regions such as driver mounting areas or cabinet junctions. The panels may be square, rectangular, wedge shaped, circular, oval or a custom shape to fit within the spaces between internal cabinet bracings. The panels may be of differing thicknesses and densities to suit both the speaker cabinet construction and fine-tuning of the PID chambers and particles for the effective absorption of vibration. The internal PID chambers within the panels can also be configured in a variety of shapes, including but not limited to circular, rectangular, hexagonal, or irregular geometries, to optimize vibration absorption.

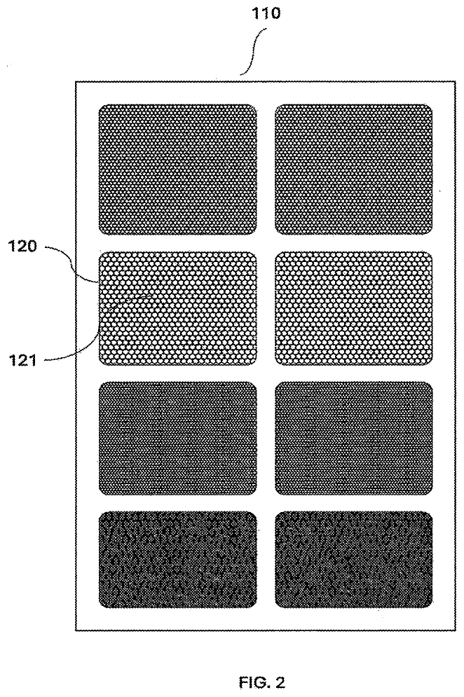

FIG. 2 illustrates a cross-section through one such example of a panel 110 with 8 PID chambers 120. The particles 121 which may vary in size, weight, shape, fill levels and material, move upon exposure to vibration, dissipating it as heat through collision and friction. The selection of particle properties enables broadband vibration mitigation across a broad frequency range. PIDs may comprise materials such as metal beads, ceramic particles, polymer granules, or organic material, each chosen based on their density and energy dissipation characteristics.

The ability to fine-tune position of each panel, the PID chambers and the particle composition, fill levels and material characteristics, helps to ensure that vibrations are controlled precisely where they occur, contributing to improved overall performance. For example, in loudspeaker cabinets, heavier larger particles to absorb lower frequency vibrations could be used at the base of the speaker frame, and around and behind the bass driver, or lighter smaller particles to absorb higher frequency vibrations could be used around the tweeters.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A speaker cabinet vibration management system, comprising:
a panel disposed within an interior of a loudspeaker cabinet and configured to flex in response to cabinet vibrations to transmit the vibrations; and
a plurality of particle impact dampers (PIDs) integrated into the panel,
each PID comprising an enclosed chamber containing loose particles that dissipate the transmitted vibrations through collisions with each other and with the walls of the chamber.

2. The system of claim 1, wherein the panel is constructed from at least one compliant material selected for its elasticity, density, and compatibility with the loudspeaker cabinet's internal structure.

3. The system of claim 1, wherein the panel comprises a rigid support frame and a compliant layer on an outward-facing surface of the frame,
the compliant material being selected based on its elasticity, density, and compatibility with the loudspeaker cabinet's internal structure.

4. The system of claim 1, wherein a PID contains a plurality of particles of varying sizes, fill levels, shapes, and material compositions to enable vibration damping across a broad range of frequencies.

5. The system of claim 1, wherein the panel is positioned strategically within the loudspeaker cabinet to maximize the transmission of mechanically induced cabinet vibration into the particle impact dampers.

6. The system of claim 1, wherein a PID is configured to dissipate vibration through particle collisions and friction, thereby reducing the amplitude of the cabinet vibrations.

7. The system of claim 1, wherein the panel is configured to facilitate the transmission of vibration into a PID, thereby enhancing the efficiency of energy dissipation.

8. The system of claim 1, wherein the panel and a PID form a modular system that allows the number and placement of damping components to be customized for different loudspeaker cabinet designs.

9. The system of claim 1, wherein a combination of the panel and a PID provide vibration damping across a broad frequency range, thereby improving audio fidelity by reducing parasitic vibrations in the loudspeaker cabinet.

10. The system of claim 1, wherein the panel is attached within the cabinet by at least one of an adhesive, glue, a screw, an adhesive tape, a clip, or other fastener.

11. The system of claim 1, wherein the panel is held in place by a magnet, a friction fit, or a tensioning mechanism.

12. The system of claim 1, wherein the panel is embedded into a pre-formed pocket or a recess in the interior surfaces of the loudspeaker cabinet.

13. The system of claim 1, wherein the panel is flat, curved, or sufficiently flexible to conform to both planar and curved interior surfaces of the cabinet.

14. The system of claim 1, wherein the panel is arranged across an interior wall of the loudspeaker cabinet.

15. The system of claim 1, wherein the panel is square, rectangular, wedge-shaped, circular, oval, or another custom shape sized to fit into spaces between internal cabinet bracing members.

16. The system of claim 1, wherein the panel comprises a deformable panel.

17. The system of claim 1, wherein the panel comprises a rigid or semi-rigid body mounted via a compliant interface, enabling effective vibration transmission to the PID chambers.

18. A method for reducing vibrations in a loudspeaker cabinet, comprising:
providing a loudspeaker cabinet and installing a panel in an interior of the cabinet;
embedding a particle impact damper (PID) within the panel;
capturing vibrations generated by a speaker driver using the panel; and
dissipating the captured vibrations through movement of particles within the PID.

19. The method of claim 18, wherein the panel is positioned to optimize a transmission of vibrations into the PID.

20. The method of claim 18, further comprising the step of selecting properties of the particles, including particle size, fill level, shape, and material composition, to provide damping across a broad range of frequencies.

21. (canceled)

22. (canceled)

23. (canceled)
